(19) United States
(12) Patent Application Publication
(10) Pub. No.: US 2026/0052021 A1
(43) Pub. Date: Feb. 19, 2026

(54) METHOD, APPARATUS, AND COMPUTER-READABLE MEDIUM OF A BLOCK CHAIN NETWORK FOR IMPLEMENTING A CONSENSUS PROTOCOL

(71) Applicant: Kunato Inc., New York, NY (US)

(72) Inventors: Illan POREH, New York, NY (US); Manvir SINGH, Bangalore (IN)

(21) Appl. No.: 19/298,466

(22) Filed: Aug. 13, 2025

Related U.S. Application Data
(60) Provisional application No. 63/682,361, filed on Aug. 13, 2024.

(51) Int. Cl. H04L 9/32; H04L 9/00

(52) U.S. Cl. CPC H04L 9/3236; H04L 9/50

(57) ABSTRACT

A method, apparatus, and computer-readable medium for implementing a consensus protocol on a block chain network, including assigning a plurality of dual-mode nodes of the block chain network to a plurality of block numbers, identifying a dual-mode node in the plurality of dual- mode nodes that is assigned to a next block number in the plurality of block numbers, mining, with the assigned dual-mode node, a block of one or more unconfirmed transactions on the block chain network to generate a proposed new block for addition to the block chain network, validating, with one or more non-assigned dual-mode nodes in the plurality of dual-mode nodes, the proposed new block, and minting, with the assigned dual-mode node, the proposed new block as the next block in the block chain network based at least in part on successful validation of the proposed new block by the one or more non-assigned dual-mode nodes.

### RELATED APPLICATION DATA

This application claims priority to U.S. Provisional Application No. 63/682,361, filed Aug. 13, 2024, the disclosure of which is hereby incorporated by reference in its entirety.

### BACKGROUND

Existing block chain systems can be run on a single server/node but typically utilize multiple nodes to ensure high availability, cross-validation, and security against the danger of exploitation of a single node/server. Multiple nodes in a private centralized blockchain are useful for load-balancing in order to share the load among the various servers.

However, existing systems only split the load of minting new blocks. Regardless of whether a particular node is minting a new block, all nodes still perform significant processing to verify any block they receive from other nodes and as part of the consensus protocol used in block chains.

In particular, existing block chains, such as Bitcoin, use a consensus protocol called Proof of Work (PoW) to mine and validate new blocks. This requires a mining node to demonstrate that it has completed the computationally intensive work of computing a hash of a new block. PoW requires that all nodes in a network attempt to solve complex cryptographic challenges, with the winning node adding the new block to the block chain and being rewarded by receiving transaction fees. In effect, all the nodes are in a race to mine the block first. If there are 100 nodes in the network and each one of them is trying to solve the cryptographic has problem first, it takes roughly 100 times more energy to solve it. This process is highly inefficient, slow, and expensive. For example, the Bitcoin network consumes more electricity than Google, despite only handling a fraction of the users and network requests.

Accordingly, improvements are needed in consensus protocols for block chain networks.

### BRIEF DESCRIPTION OF DRAWINGS

FIG. 1 illustrates a flowchart for implementing a consensus protocol according to an exemplary embodiment.

FIG. 2 illustrates a diagram of the node sorting process according to an exemplary embodiment.

FIG. 3 illustrates a diagram node scheduling according to an exemplary embodiment.

FIGS. 4A-4G illustrate an example of an iteration of the consensus protocol on a block chain network according to an exemplary embodiment.

FIG. 5 illustrates a flowchart for reassigning nodes in response to addition or removal of nodes according to an exemplary embodiment.

FIG. 6 illustrates a flowchart for reassigning a node in response to failure of a node according to an exemplary embodiment.

FIGS. 7A-7C illustrate an example of the node failover proces according to an exemplary embodiment.

FIG. 8 illustrates the components of the specialized computing environment configured to perform the processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, apparatus, and computer-readable medium for implementing a consensus protocol on a block chain network that resolves existing problems in the field. As used herein, the terms “block chain” and “blockchain” are used interchangeably and refer to distributed digital ledgers that enables secure, transparent, and unalterable record-keeping and transaction processing.

The present system addresses the computational issues with Proof of Work by introducing Proof of Equality. In Proof of Equality, all nodes are dual-mode nodes that can operate in either a mining mode or a validation node and all nodes get a chance to mine new blocks. No single node is given priority over other nodes and does not compete with other nodes, despite having differences in processing power or internet bandwidth. In other words, if there are 100 nodes in the network and 100 blocks to be mined, then each of the nodes can mine one block. As explained in greater detail below, a selection and assignment process is used to schedule blocks with nodes and to assign new blocks to appropriate nodes, which dynamically adapt their mode to the assignments. The present system completely removes the need to run millions of cryptographic calculations to mine a new block and makes process of mining a block faster and more computationally and energy efficient.

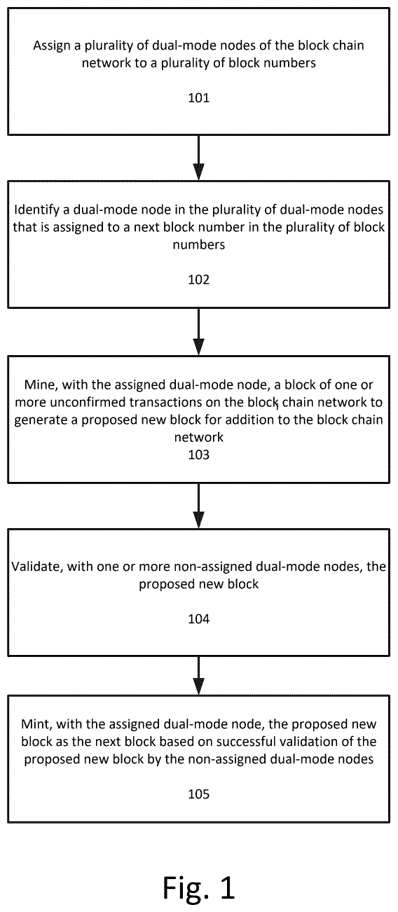

FIG. 1 illustrates a flowchart for implementing a consensus protocol according to an exemplary embodiment. The steps shown in FIG. 1 can be executed by one or more computing devices of a block chain network. The one or more computing devices can be distributed over nodes of the block chain network, each of which can store copies of the consensus protocol.

At step 101 a plurality of dual-mode nodes of the block chain network are assigned to a plurality of block numbers. The dual-mode nodes are nodes that can operate in two different modes, including a mining mode for mining and adding new blocks to the block chain and a validation mode for validating blocks mined by other nodes. Of course, the nodes can have additional modes, such as an idle mode, in which the node does not participate at all in either the mining or validation of a block, or other modes.

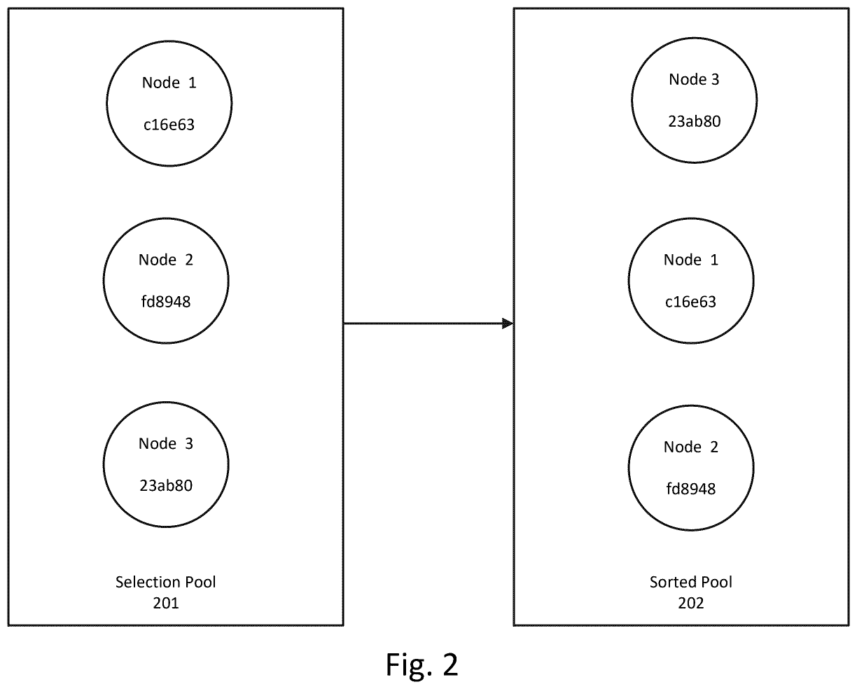

The block numbers correspond to upcoming blocks which have not yet been mined and which are not currently on the block chain. Each dual-mode node is assigned one or more block numbers in the plurality of block numbers. Optionally, the block chain network can sort the dual-mode nodes prior to performing the assignment. FIG. 2 illustrates a diagram of the node sorting process according to an exemplary embodiment. As shown in FIG. 2, the selection pool 201 includes all the nodes in the network. The block chain network can put the public address/public key of all the nodes in a list or array and sort it by ascending or descending order. The sorted pool 202 shown in FIG. 2 illustrates the nodes sorted by public key in ascending order.

After sorting, the nodes can be assigned to upcoming blocks/block numbers. Optionally, the plurality of dual-mode nodes of the block chain network can be assigned to the plurality of block numbers based at least in part on a random or pseudo-random function.

The step of assigning a plurality of dual-mode nodes of the block chain network to a plurality of block numbers can also include determining a dual-mode node assigned to each block number based at least in part on a total quantity of dual-mode nodes and a block height of blocks to mine. The nodes can be assigned in a round-robin technique in which the node at the first position is configured to mine the first upcoming block (i.e., the first new block or next highest block). The block number of the first upcoming block can be determined based on the current block height of the block chain. For example, if the block height of the block chain is five, then there are five stored blocks and the next block number would be block six. After assignment of the first node, the node at the second position can be assigned mine the second upcoming block. The assignment continues in the same way until the last node, at which point a round of assignments is complete. After a round finishes, the next round can start with nodes mining the blocks in the same order. After the last node is done mining, the cycle repeats from the beginning with first node mining the n+1 block, where n is the number of all the nodes in the network.

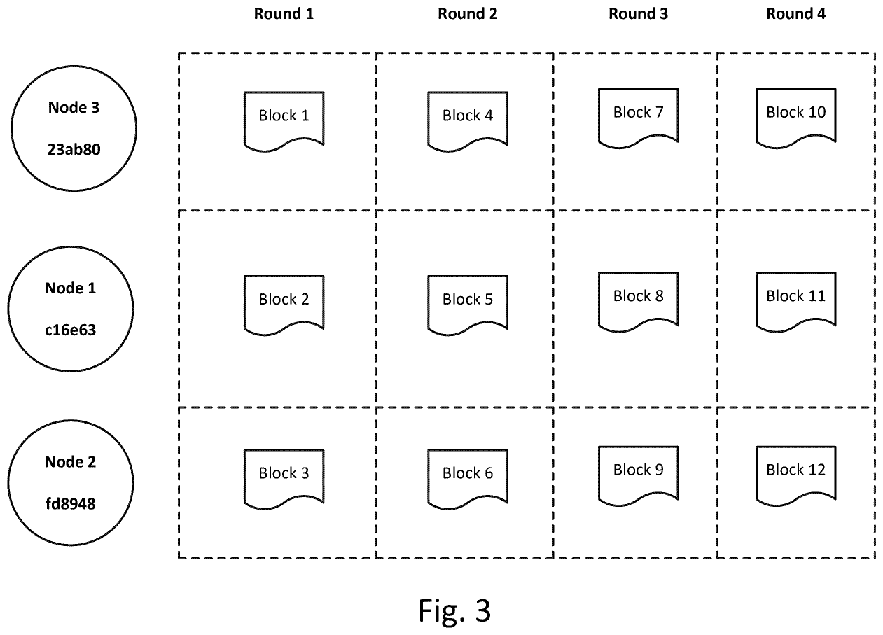

FIG. 3 illustrates a diagram of node scheduling according to an exemplary embodiment. The nodes shown in FIG. 3 can be assigned using the techniques described above. As shown in FIG. 3, Node 3 is assigned to Block 1 (i.e., the next upcoming block), Block 4, Block 7, and Block 10, Node 1 is assigned to Block 2, Block 5, Block 8, and Block 1, Node 2 is assigned to Block 3, Block 6, Block 9, and Block 12. Node assignments can be computed and stored at the nodes ahead of time or can be dynamically calculated on the fly as blocks are processed.

As discussed above, each dual-mode node is configured to operate in a mining role when the block chain network is processing block numbers assigned to that dual-mode node and configured to operate in a validator role when the block chain network is processing block numbers not assigned to that dual-mode node. After completion of a mining operation, the dual-mode node can automatically revert from a mining role to a validator role. Optionally, the node can have a third mode in which it is idle and other nodes perform the mining and validation. For example, in a network with five nodes, a single node can perform mining, two nodes can serve as validators, and two nodes can be idle to save computing resources.

Returning to FIG. 1, at step 102 a dual-mode node in the plurality of dual-mode nodes that is assigned to a next block number in the plurality of block numbers is identified. The next block number is a block number subsequent to a current block height of the block chain network. For example, if the block height is six, then the next block number would be block seven. Of course, the simple block numberings described herein are presented for clarity only, and it is understood that the block numbers can be public keys of the blocks and the next block number can be the next highest public key block.

The identification of the dual-mode node assigned to the next block number can be determined using a stored list of assignments, as discussed previously. The identification of the dual-mode node assigned to the next block number can also be determined based at least in part on a formula. Using the below formula, each node can check whether it is their turn to mine a block and which node is responsible for mining n-th block:

$$n - ( ⌈ \frac{n}{y} ⌉ - 1 ) y$$

In the above formula, where n is the height of the block to mine and y is total number of miner nodes in the network. The height of the block to mine is the existing block height of the block chain plus one. In this case, [n/y] identifies the current round with the ceiling of division of n with y. For example, given a current block height of 4 (resulting in the height of the block to mine of 5 (n=5)) and given a total number of nodes of 3 (y=3), the term (ceiling) [n/y] results in a value of 2 (ceiling of 5/3) and the formula results in the value 5−(2−1)3=2, meaning that the second node is responsible for mining the 5th block. As each node in the block chain network stores the consensus protocol, each node can determine whether is it is assigned to the next block using the formula above.

At step 103 the assigned dual-mode node of the block chain network is used to mine a block of one or more unconfirmed transactions on the block chain network to generate a proposed new block for addition to the block chain network. The process of mining the block of one or more unconfirmed transactions can include computing a cryptographic hash value based at least in part on data in the block of one or more unconfirmed transactions. For example, the node can use specialized hardware and/or software to perform calculations and find a solution to a cryptographic puzzle based on the data in the block. The puzzle can include finding a specific “hash” value that meets certain criteria, such as finding a number that, when combined with the data in the block, produces a hash that starts with a certain number of zeros.

Optionally, the process of mining the block can omit the complex cryptographic calculations described above and alternatively or additionally include validating the unconfirmed transactions that form the block. This can include verifying transactions based on the signatures in the block, the funds available to the parties, or other factors. For example, the mining node can examine transactions and the block chain to ensure that there are sufficient funds, proper digital signatures, and adherence to protocols and rules.

When the assigned dual-mode node has completed the mining and generated the proposed new block, the proposed new block can be broadcast by the assigned dual-mode node to one or more non-assigned dual-mode nodes in the block chain network. For example, the proposed new block can be broadcast to all other dual-mode nodes in the block chain network. Alternatively, the proposed new block can be broadcast or sent to a subset of the other dual-mode nodes (i.e., if some of the nodes are idle).

At step 104 the one or more non-assigned dual-mode nodes in the plurality of dual-mode nodes of the block chain network validate the proposed new block. The step of validating the proposed new block can include validating a cryptographic hash value generated by the assigned dual-mode node. Verification of the hash value can be accomplished more quickly that the time required to solve for the hash by applying the hash to the data in the block to determine if the desired result is achieved. The step of validating the proposed new block can alternatively or additionally include validating the one or more unconfirmed transactions. As discussed previously, this can include verifying transactions based on the signatures in the block, the funds available to the parties, or other factors.

At step 105 the assigned dual-mode node of the block chain network mints the proposed new block as the next block in the block chain network based at least in part on successful validation of the proposed new block by the one or more non-assigned dual-mode nodes. The consensus protocol can define whether validation is successful. In particular, the consensus protocol can require that the validation requires certain quantity or percentage of the non-assigned dual-mode nodes to validate the proposed new block. For example, the consensus protocol can require unanimous validation by all non-assigned dual-mode nodes, validation by the majority of non-assigned dual-mode nodes, validation by all non-assigned dual-mode nodes that conduct the validation (i.e., not by idle nodes), or validation by the majority of non-assigned dual-mode nodes that conduct the validation (i.e., not including idle nodes).

The newly minted block is then added to the block chain (copies of which are stored on all nodes). The assigned dual-mode node can broadcast, transmit, or otherwise send the minted block to the non-assigned dual-mode nodes of the block chain network, which can then update their internal copies of the block chain.

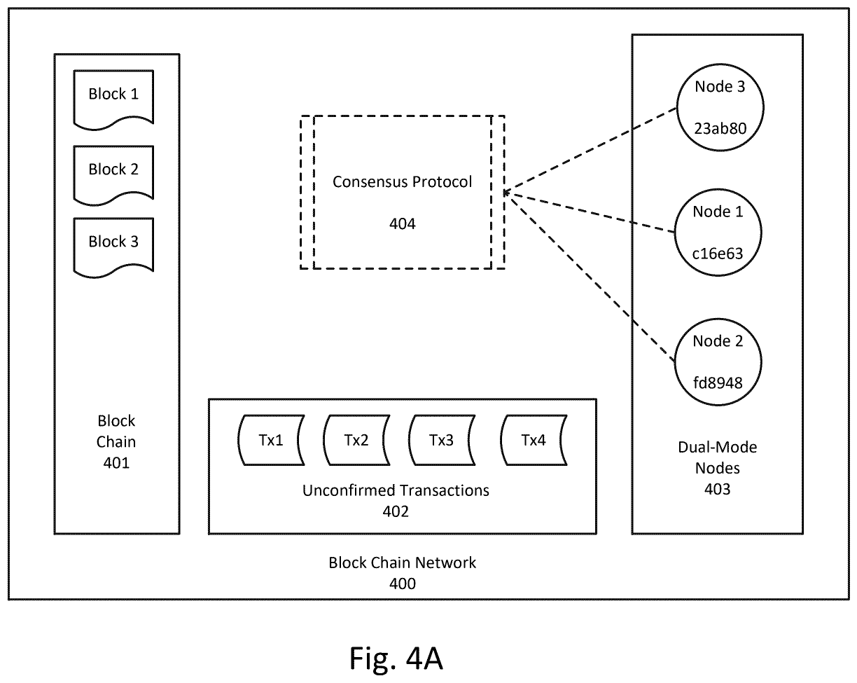

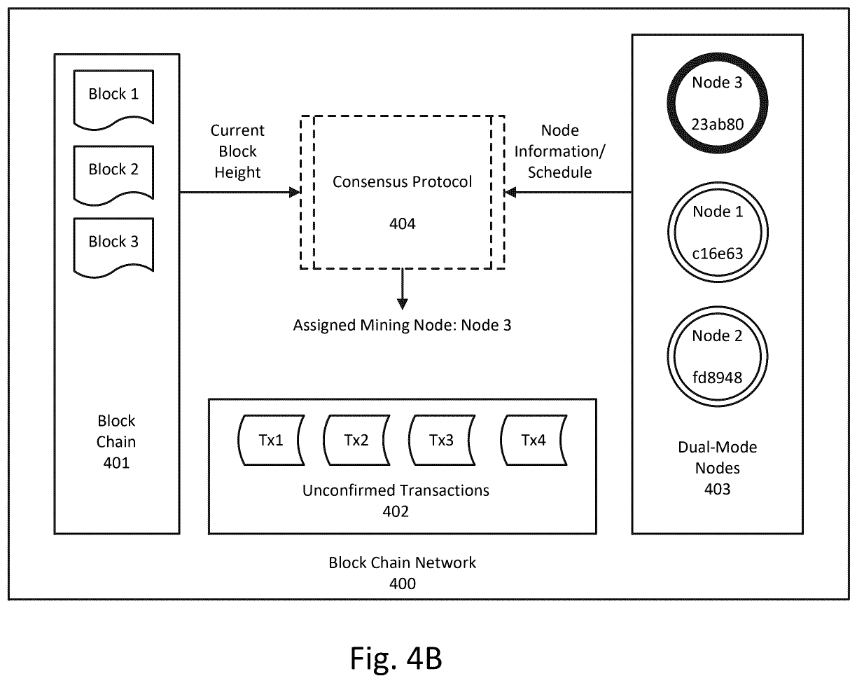

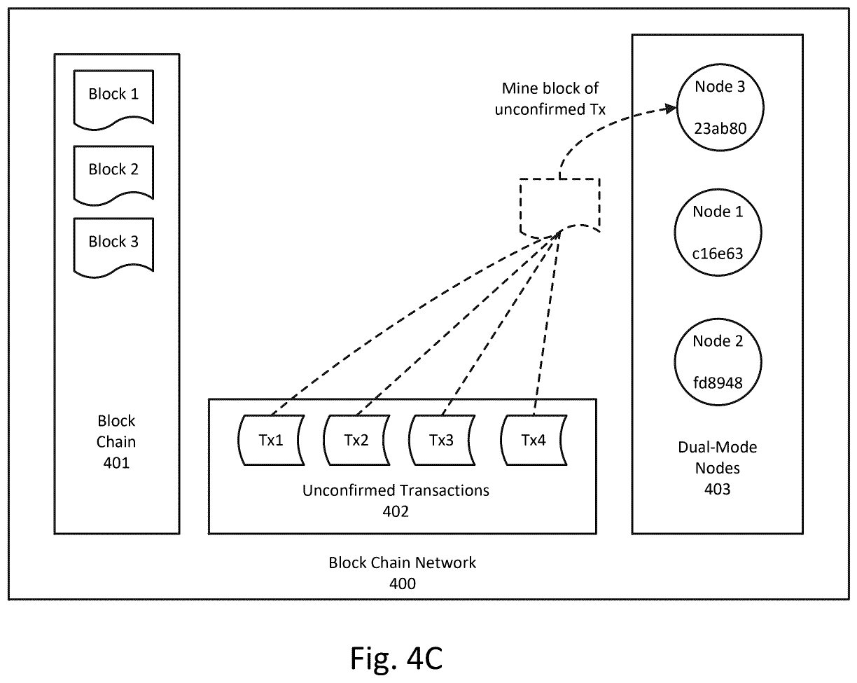

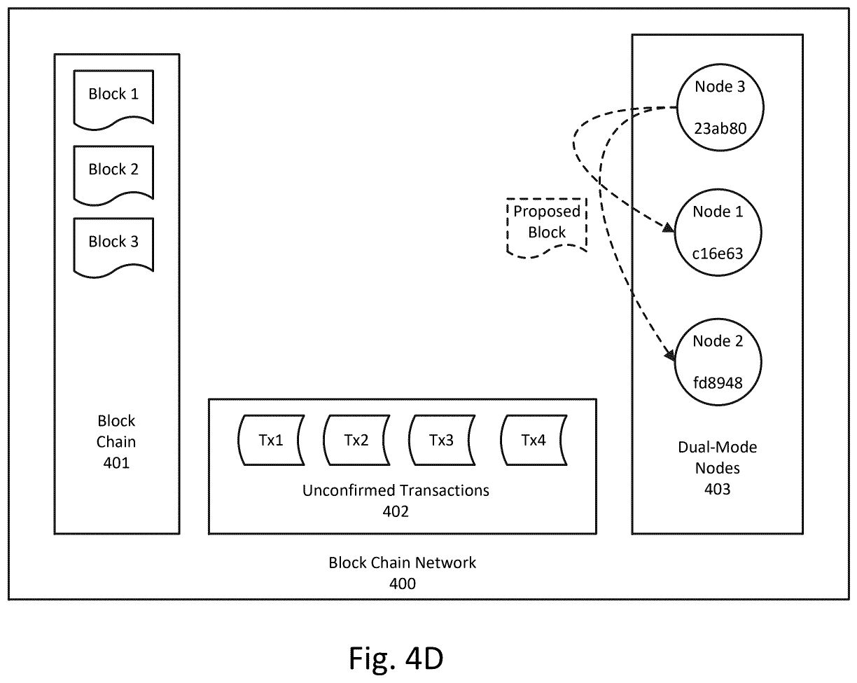

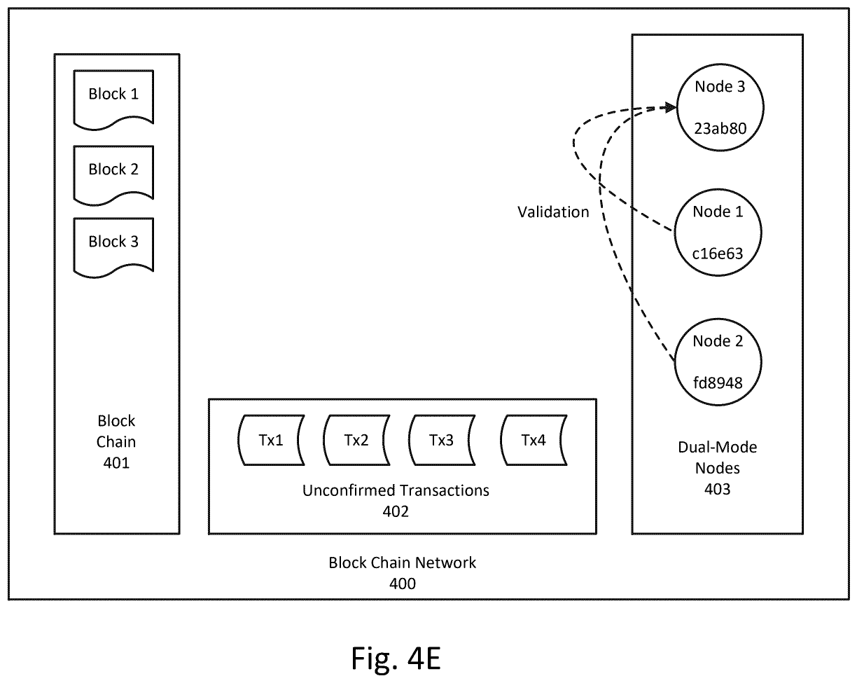

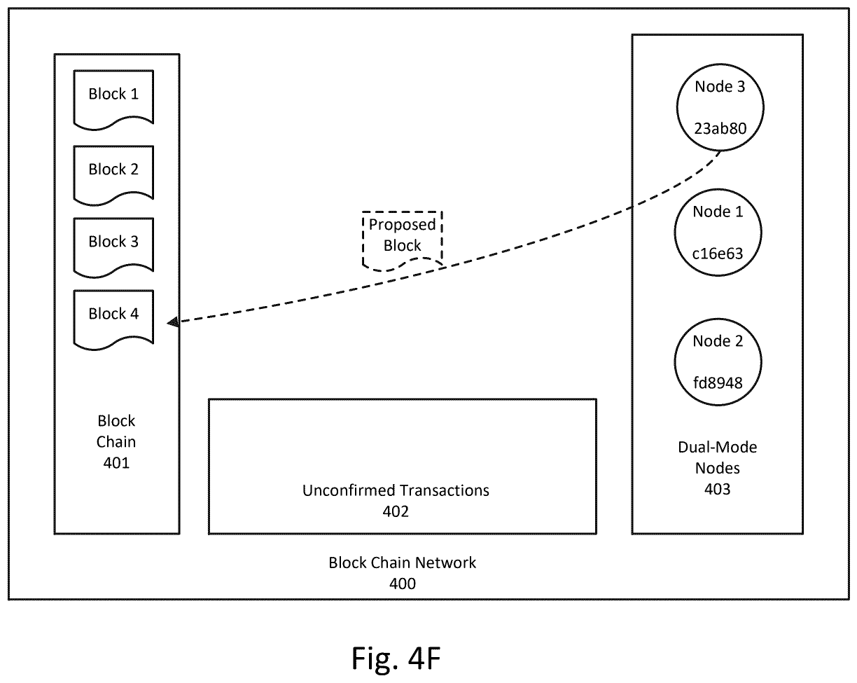

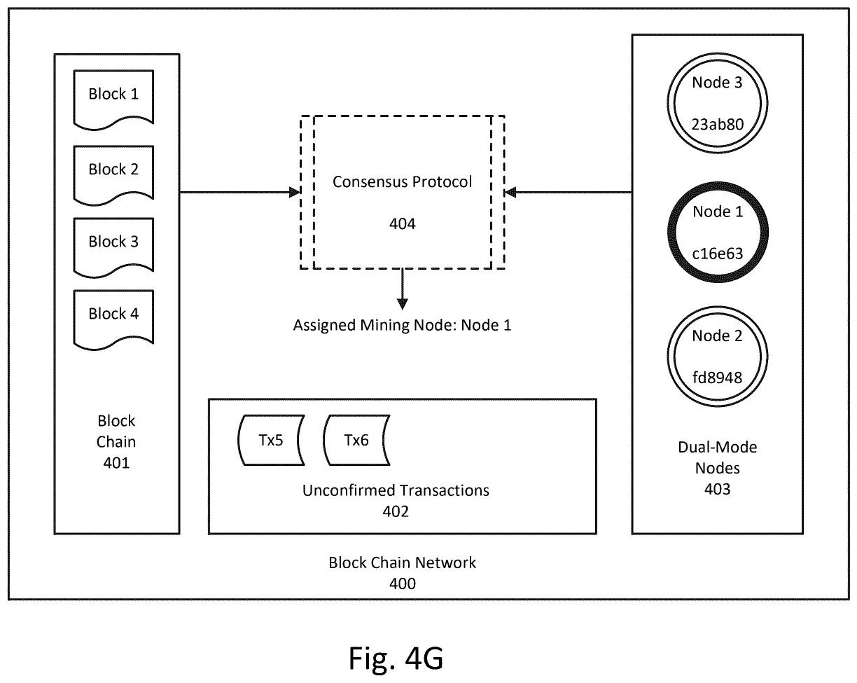

FIGS. 4A-4G illustrate an example of an iteration of the consensus protocol on a block chain network according to an exemplary embodiment.

As shown in FIG. 4A, the block chain network 400 includes dual-mode nodes 403, including Node 1, Node 2, and Node 3. The network 400 additionally includes a ledger or block chain 401 which stores blocks of confirmed transactions and other data, including block 1, block 2, and block 3. While the block chain 401 is shown in the figure as a separate entity for clarity purposes, it is understood that in practice, copies of the block chain 401 will be stored on each of the dual-mode nodes 403.

The block chain network 400 additionally includes a block of unconfirmed transactions 402 which have not yet been verified added to the ledger (block chain). Again, the unconfirmed transactions are shown separate from nodes 403 for clarity, but it is understood that in practice the unconfirmed transactions will be stored on one or more nodes of the dual-mode nodes 403.

As additionally shown in FIG. 4A, the block chain network 400 executes a consensus protocol 404. Copies of the consensus protocol 404 are stored on each of the nodes in the dual-mode nodes 403, which execute the consensus protocol 404. The consensus protocol 401 executes the methods and processes described herein.

FIG. 4B illustrates an example of the identification of a mining node for the next block number. As shown in in FIG. 4B, node information (such as total number of nodes, identity of nodes, etc.) and/or a schedule (which can be predetermined and stored ahead of time, as discussed before) are used by the consensus protocol 404, along with the current block height, to identify a dual-mode node in the dual-mode nodes that is assigned to mine the next block.

In this case, the assigned mining node is Node 3. As discussed previously, the consensus protocol 404 is stored on each node and executes on each node. Therefore, each of the dual-mode nodes 403 can execute a copy of the consensus protocol to determine whether it is the node assigned to mining the next block. Since Node 3 is the assigned mining node, this node operates in a mining configuration/role, indicated by black ring around the Node 3. The nodes which are not assigned to mine the next block, Node 1 and Node 2, operate in a validator role, indicated by the white rings around Node 1 and Node 2.

FIG. 4C illustrates the mining of the next block. As shown in FIG. 4C, a block corresponding to the unconfirmed transactions 402 is mined by Node 3. As discussed previously, mining can include verification of transactions, solving cryptographic problems, and/or other processes.

After mining is complete, Node 3 generates a proposed new block for addition to the block chain in the block chain network. As shown in FIG. 4D, this proposed block is sent to the other nodes, Node 1 and Node 2, for validation. If the other nodes validate the proposed new block, then this validation is sent back to Node 3, as shown in FIG. 4E.

If the proposed new block is successfully validated, then the proposed block is added to the block chain as a new block, as shown in FIG. 4F. In this case, the proposed new block is added to the block chain as block 4. As discussed previously, copies of the block chain 401 are stored on each of the dual-mode nodes, so this step includes adding the new block to the block chain stored on each of the dual-mode nodes. This can be performed by instructing each of the non-assigned nodes to add the block that they have validated to their copy of the block chain, sending the proposed block to the non-assigned nodes for addition to their copy of the block chain, and/or sending an updated copy of the block chain from the assigned node to the other nodes. Once the block is validated and added to the block chain, all of the unconfirmed transactions are then confirmed.

After the new block is added to the block chain, then the process repeats. FIG. 4G illustrates the next step of identifying a mining node for the next block (i.e., block 5) to be added to the block chain. As shown in FIG. 4G, the assigned mining node for the next block is Node 1. Since Node 1 is the assigned mining node, this node operates in a mining configuration/role, indicated by black ring around the Node 1. The nodes which are not assigned to mine the next block, Node 3 and Node 2, operate in a validator role, indicated by the white rings around Node 3 and Node 2. As demonstrated by FIGS. 4A-4G, once an assigned node has mined its block, it turns into a validation node and another node becomes a mining node. In this way the responsibility of mining a block is evenly rotated between all nodes.

As discussed previously, the nodes can be assigned to blocks by the block chain network (via the consensus protocol) based at least in part on a current block height of the block chain and the total number/quantity of dual-mode nodes on the block chain network. If the total number of nodes on the block chain network changes, then the nodes can be reassigned to upcoming blocks as necessary.

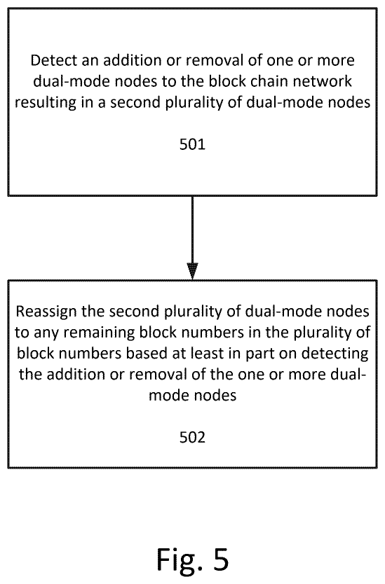

FIG. 5 illustrates a flowchart for reassigning nodes in response to addition or removal of nodes according to an exemplary embodiment. At step 501 the block chain network detects an addition or removal of one or more dual-mode nodes to the block chain network. This addition or removal results in a second plurality of dual-mode nodes, different than the first plurality of dual-mode nodes that were originally in the system.

At step 502 block chain network reassigns the second plurality of dual-mode nodes to any remaining block numbers in the plurality of block numbers based at least in part on detecting the addition or removal of the one or more dual-mode nodes. This reassignment process can be similar to the assignment process discussed previously with respect to step 101 of FIG. 1.

In the consensus protocol of the present system, only the selected miner can mine the block and the other nodes wait for the mining to complete. However, if the selected miner node becomes unresponsive or experiences some error, this can pause the whole system. Therefore, the consensus protocol includes procedures to address failure and/or time-out of a node in the block chain network.

The present system transmits incoming (unconfirmed) transactions to the whole network. The assigned miner has only a predetermined time period (such as a few seconds) to mine the next block and send a confirmation to the rest of the network. If the confirmation is not received in acceptable time limit, the assigned node is kicked out of selection process and a new node is selected to take its place.

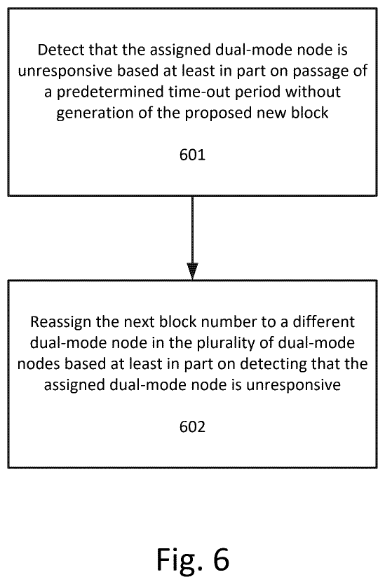

FIG. 6 illustrates a flowchart for reassigning a node in response to failure of a node according to an exemplary embodiment. At step 601 the block chain network detects that the assigned dual-mode node is unresponsive based at least in part on passage of a predetermined time-out period without generation of the proposed new block. This step can be performed at any time during the process shown in FIG. 1, as each node is aware of the assigned node for the next block, so if the assigned node does not produce a proposed new block within a predetermined time-out or failure period, then the other nodes will detect that the assigned node is unresponsive.

At step 602 the block chain network reassigns the next block number to a different dual-mode node in the plurality of dual-mode nodes based at least in part on detecting that the assigned dual-mode node is unresponsive. This step can include re-assigning subsequent blocks, in addition to the current block, to rebalance the allocation of blocks among the remaining nodes. When the unresponsive nodes comes online, it can then rejoin the network and the selection/assignment process is refreshed with the omitted node now being a part of the process, as shown by the reassignment process of FIG. 5.

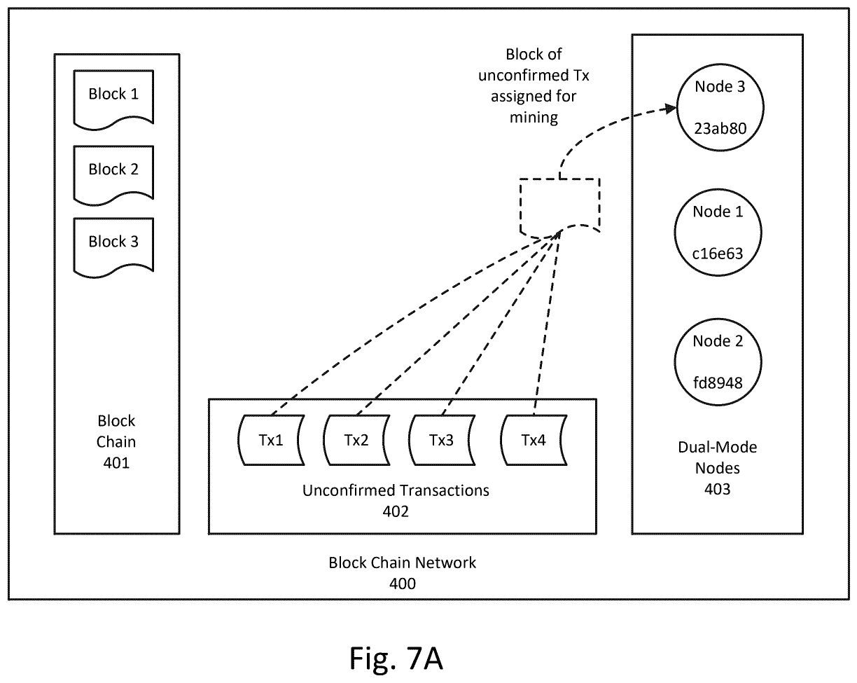

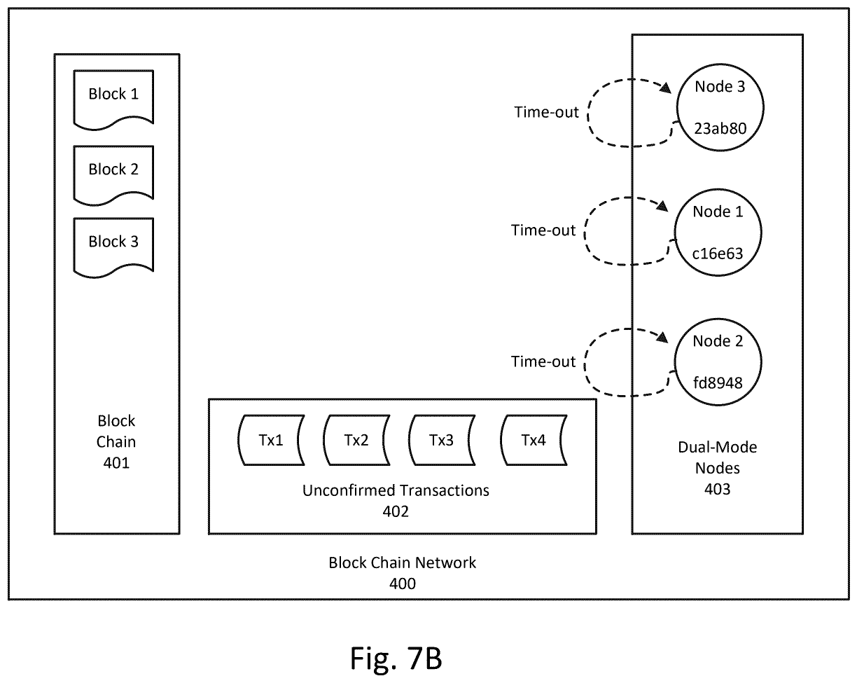

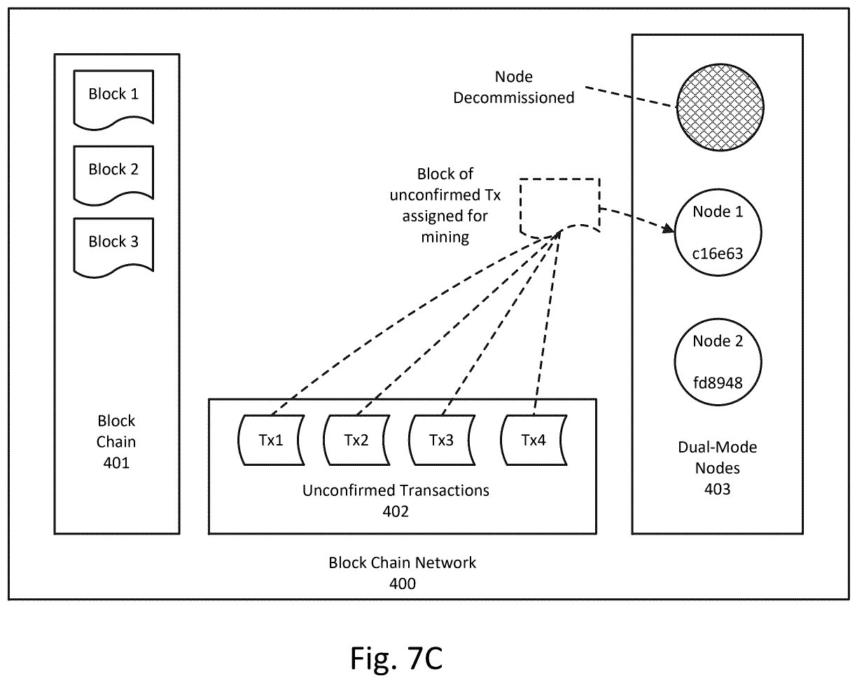

FIGS. 7A-7C illustrate an example of the node failover process according to an exemplary embodiment. As shown in FIG. 7A, Node 3 is assigned to mine a block corresponding to unconfirmed transactions 402. FIG. 7B illustrates the time-out process occurring at Node 3, Node 1, and Node 2 due to Node 3 not being able to determine a proposed block and no confirmation being received by Node 1 and Node 2. The time-out period can range from a few milliseconds to a few seconds to a longer period, such as a few minutes, depending on the specific application. After the time-out period passes, then the block of unconfirmed transaction is reassigned to another node. FIG. 7C illustrates the block being reassigned to Node 1 for mining. Additionally, Node 1, which was unresponsive, is decommissioned until it comes back online again (e.g., by sending a status message to other nodes). The block assignments can also be rescheduled for future blocks based on the decommissioning of Node 3.

The present system provides a highly efficient and fast technique for validating new transactions on a block chain network. Since the selection process can be configured to only occur when there is a change in the number of nodes, there is no need to select a miner for every single block. Instead, miners are selected for up to an infinite number of incoming blocks in a single step. Additionally, a new block can be mined instantly, as soon as even a single unconfirmed transaction. This allows the network to update the block chain in real-time, meaning users and clients do not have to wait more than few milliseconds to receive confirmation of a successful transaction.

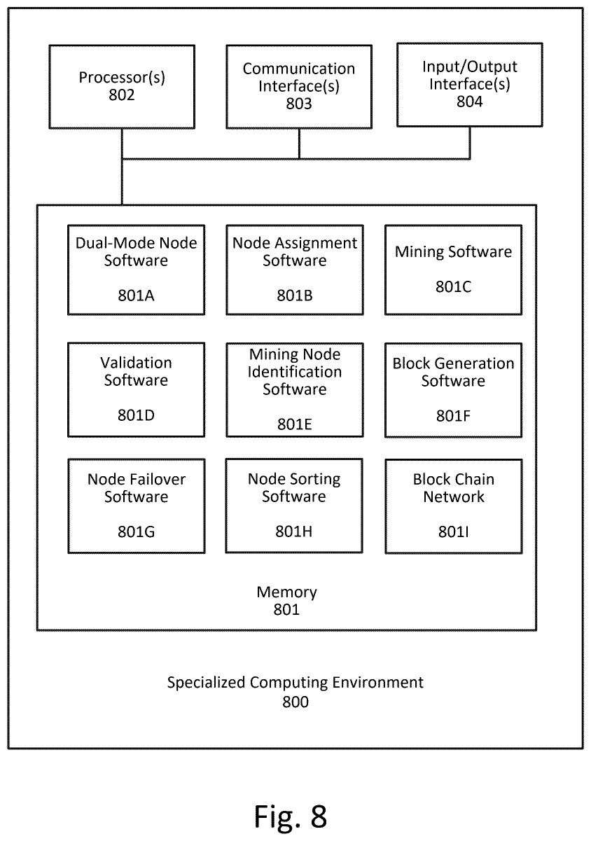

FIG. 8 illustrates the components of the specialized computing environment configured to perform the processes described herein. Specialized computing environment 800 is a computing device that includes a memory 801 that is a non-transitory computer-readable medium and can be volatile memory (e.g., registers, cache, RAM), non-volatile memory (e.g., ROM, EEPROM, flash memory, etc.), or some combination of the two.

As shown in FIG. 8, memory 801 can include dual-mode node software 801A, node assignment software 801B, mining software 801C, validation software 801D, mining node identification software 801E, block generation software 801F, node failover software 801G, node sorting software 801H, block chain network 801J. Each of the software components in memory 801 store specialized instructions and data structures configured to perform the corresponding functionality and techniques described herein.

All of the software stored within memory 801 can be stored as a computer-readable instructions, that when executed by one or more processors 802, cause the processors to perform the functionality described with respect to FIGS. 1-7.

Processor(s) 802 execute computer-executable instructions and can be real or virtual processors. In a multi-processing system, multiple processors or multicore processors can be used to execute computer-executable instructions to increase processing power and/or to execute certain software in parallel.

Specialized computing environment 800 additionally includes a communication interface 803, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 800 further includes input and output interfaces 804 that allow users (such as system administrators) to provide input to the system to set parameters, to edit data stored in memory 801, or to perform other administrative functions.

An interconnection mechanism (shown as a solid line in FIG. 8), such as a bus, controller, or network interconnects the components of the specialized computing environment 800.

Input and output interfaces 804 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 800.

Specialized computing environment 800 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 800.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed. but it is intended to cover modifications within the spirit and scope of the present disclosure as defined by the appended claims.

1. A method executed by one or more computing devices of a block chain network for implementing a consensus protocol, the method comprising:
assigning, by the block chain network, a plurality of dual-mode nodes of the block chain network to a plurality of block numbers, wherein each dual-mode node is assigned one or more block numbers in the plurality of block numbers and wherein each dual-mode node is configured to operate in a mining role when the block chain network is processing block numbers assigned to that dual-mode node and configured to operate in a validator role when the block chain network is processing block numbers not assigned to that dual-mode node;
identifying, by the block chain network, a dual-mode node in the plurality of dual-mode nodes that is assigned to a next block number in the plurality of block numbers, the next block number comprising a block number subsequent to a current block height of the block chain network;
mining, with the assigned dual-mode node of the block chain network, a block of one or more unconfirmed transactions on the block chain network to generate a proposed new block for addition to the block chain network;
validating, with one or more non-assigned dual-mode nodes in the plurality of dual-mode nodes of the block chain network, the proposed new block; and
minting, with the assigned dual-mode node of the block chain network, the proposed new block as the next block in the block chain network based at least in part on successful validation of the proposed new block by the one or more non-assigned dual-mode nodes.

2. The method of claim 1, wherein the plurality of dual-mode nodes of the block chain network are assigned to the plurality of block numbers based at least in part on a random or pseudo-random function.

3. The method of claim 1, wherein the plurality of dual-mode nodes of the block chain network are assigned to the plurality of block numbers based at least in part on a total quantity of dual-mode nodes and a block height of blocks to mine.

4. The method of claim 1, further comprising:
detecting, by the block chain network, an addition or removal of one or more dual-mode nodes to the block chain network resulting in a second plurality of dual-mode nodes; and
reassigning, by the block chain network, the second plurality of dual-mode nodes to any remaining block numbers in the plurality of block numbers based at least in part on detecting the addition or removal of the one or more dual-mode nodes.

5. The method of claim 1, further comprising:
detecting, by the block chain network, that the assigned dual-mode node is unresponsive based at least in part on passage of a predetermined time-out period without generation of the proposed new block; and
reassigning, by the block chain network, the next block number to a different dual-mode node in the plurality of dual-mode nodes based at least in part on detecting that the assigned dual-mode node is unresponsive.

6. The method of claim 1, wherein mining a block of one or more unconfirmed transactions on the block chain network to generate a proposed new block for addition to the block chain network comprises computing a cryptographic hash value based at least in part on data in the block of one or more unconfirmed transactions.

7. The method of claim 1, wherein the proposed new block is validated by one or more of:
validating a cryptographic hash value generated by the assigned dual-mode node; or
validating the one or more unconfirmed transactions.

8. An apparatus for implementing a consensus protocol on a block chain network, the apparatus comprising:
one or more processors; and
one or more memories operatively coupled to at least one of the one or more processors and having instructions stored thereon that, when executed by at least one of the one or more processors, cause at least one of the one or more processors to:
assign a plurality of dual-mode nodes of the block chain network to a plurality of block numbers, wherein each dual-mode node is assigned one or more block numbers in the plurality of block numbers and wherein each dual-mode node is configured to operate in a mining role when the block chain network is processing block numbers assigned to that dual-mode node and configured to operate in a validator role when the block chain network is processing block numbers not assigned to that dual-mode node;
identify a dual-mode node in the plurality of dual-mode nodes that is assigned to a next block number in the plurality of block numbers, the next block number comprising a block number subsequent to a current block height of the block chain network;
mine, with the assigned dual-mode node, a block of one or more unconfirmed transactions on the block chain network to generate a proposed new block for addition to the block chain network;
validate, with one or more non-assigned dual-mode nodes in the plurality of dual-mode nodes, the proposed new block; and
mint, with the assigned dual-mode node, the proposed new block as the next block in the block chain network based at least in part on successful validation of the proposed new block by the one or more non-assigned dual-mode nodes.

9. The apparatus of claim 8, wherein the plurality of dual-mode nodes of the block chain network are assigned to the plurality of block numbers based at least in part on a random or pseudo-random function.

10. The apparatus of claim 8, wherein the plurality of dual-mode nodes of the block chain network are assigned to the plurality of block numbers based at least in part on a total quantity of dual-mode nodes and a block height of blocks to mine.

11. The apparatus of claim 8, wherein at least one of the one or more memories has further instructions stored thereon that, when executed by at least one of the one or more processors, cause at least one of the one or more processors to:
detect an addition or removal of one or more dual-mode nodes to the block chain network resulting in a second plurality of dual-mode nodes; and
reassign the second plurality of dual-mode nodes to any remaining block numbers in the plurality of block numbers based at least in part on detecting the addition or removal of the one or more dual-mode nodes.

12. The apparatus of claim 8, wherein at least one of the one or more memories has further instructions stored thereon that, when executed by at least one of the one or more processors, cause at least one of the one or more processors to:
detect that the assigned dual-mode node is unresponsive based at least in part on passage of a predetermined time-out period without generation of the proposed new block; and
reassign the next block number to a different dual-mode node in the plurality of dual-mode nodes based at least in part on detecting that the assigned dual-mode node is unresponsive.

13. The apparatus of claim 8, wherein the instructions that, when executed by at least one of the one or more processors, cause at least one of the one or more processors to mine a block of one or more unconfirmed transactions on the block chain network to generate a proposed new block for addition to the block chain network further cause at least one of the one or more processors to compute a cryptographic hash value based at least in part on data in the block of one or more unconfirmed transactions.

14. The apparatus of claim 8, wherein the proposed new block is validated by one or more of:
validating a cryptographic hash value generated by the assigned dual-mode node; or
validating the one or more unconfirmed transactions.

15. At least one non-transitory computer-readable medium storing computer-readable instructions for implementing a consensus protocol on a block chain network that, when executed by one or more computing devices, cause at least one of the one or more computing devices to:
assign a plurality of dual-mode nodes of the block chain network to a plurality of block numbers, wherein each dual-mode node is assigned one or more block numbers in the plurality of block numbers and wherein each dual-mode node is configured to operate in a mining role when the block chain network is processing block numbers assigned to that dual-mode node and configured to operate in a validator role when the block chain network is processing block numbers not assigned to that dual-mode node;
identify a dual-mode node in the plurality of dual-mode nodes that is assigned to a next block number in the plurality of block numbers, the next block number comprising a block number subsequent to a current block height of the block chain network;
mine, with the assigned dual-mode node, a block of one or more unconfirmed transactions on the block chain network to generate a proposed new block for addition to the block chain network;
validate, with one or more non-assigned dual-mode nodes in the plurality of dual-mode nodes, the proposed new block; and
mint, with the assigned dual-mode node, the proposed new block as the next block in the block chain network based at least in part on successful validation of the proposed new block by the one or more non-assigned dual-mode nodes.

16. The at least one non-transitory computer-readable medium of claim 15, wherein the plurality of dual-mode nodes of the block chain network are assigned to the plurality of block numbers based at least in part on a random or pseudo-random function.

17. The at least one non-transitory computer-readable medium of claim 15, wherein the plurality of dual-mode nodes of the block chain network are assigned to the plurality of block numbers based at least in part on a total quantity of dual-mode nodes and a block height of blocks to mine.

18. The at least one non-transitory computer-readable medium of claim 15, further storing computer-readable instructions that, when executed by one or more computing devices, cause at least one of the one or more computing devices to:
detect an addition or removal of one or more dual-mode nodes to the block chain network resulting in a second plurality of dual-mode nodes; and
reassign the second plurality of dual-mode nodes to any remaining block numbers in the plurality of block numbers based at least in part on detecting the addition or removal of the one or more dual-mode nodes.

19. The at least one non-transitory computer-readable medium of claim 15, further storing computer-readable instructions that, when executed by one or more computing devices, cause at least one of the one or more computing devices to:
detect that the assigned dual-mode node is unresponsive based at least in part on passage of a predetermined time-out period without generation of the proposed new block; and
reassign the next block number to a different dual-mode node in the plurality of dual-mode nodes based at least in part on detecting that the assigned dual-mode node is unresponsive.

20. The at least one non-transitory computer-readable medium of claim 15, wherein the instructions that, when executed by at least one of the one or more computing devices, cause at least one of the one or more computing devices to mine a block of one or more unconfirmed transactions on the block chain network to generate a proposed new block for addition to the block chain network further cause at least one of the one or more computing devices to compute a cryptographic hash value based at least in part on data in the block of one or more unconfirmed transactions.

21. The at least one non-transitory computer-readable medium of claim 15, wherein the proposed new block is validated by one or more of:
validating a cryptographic hash value generated by the assigned dual-mode node; or
validating the one or more unconfirmed transactions.
